(19) United States
(12) Patent Application Publication
(10) Pub. No.: US 2026/0204627 A1
(43) Pub. Date: Jul. 16, 2026

(54) METAL-SUBSTITUTED LITHIUM-RICH HALIDE-BASED SOLID ELECTROLYTE

(71) Applicants: Umicore, Brussels (BE); Centre National De La Recherche Scientifique, Paris (FR); UNIVERSITE DE PICARDIE JULES VERNE, Amiens (FR)

(72) Inventors: Jérémie AUVERGNIOT, Grenoble (FR); Shinichi KUMAKURA, Olen (BE); Julien PORQ, Paris (FR); Virginie VIALLET, Amiens (FR); Claude GUÉRY, Amiens (FR)

(21) Appl. No.: 19/138,230

(22) PCT Filed: Oct. 10, 2023
(86) PCT No.: PCT/EP2023/077968

§ 371 Date: Jun. 12, 2025

(30) Foreign Application Priority Data
Dec. 13, 2022 (EP) 22290072.2

(51) Int. Cl. H01M 10/0562

(52) U.S. Cl. CPC H01M 10/0562; H01M 2300/008; H01M 2300/0094

(57) ABSTRACT

The present invention relates to a metal-substituted lithium-rich solid electrolyte, a method for manufacturing said solid electrolyte and a battery comprising said solid electrolyte. These solid electrolytes display an increased ionic conductivity. Furthermore, the battery comprising the solid electrolyte according to the invention have an optimized capacity.

### TECHNICAL FIELD AND BACKGROUND

This invention relates to a metal-substituted lithium-rich solid electrolyte material, a method for manufacturing said solid electrolyte and a battery comprising said solid electrolyte.

As the development of small and lightweight electronic products, electronic devices, communication devices and the like has advanced rapidly and a need for electric vehicles has widely emerged with respect to environmental issues, there is a demand for improvement of performance of secondary batteries used as power sources for these products. Among these, a lithium secondary battery has come into the spotlight as a high-performance battery due to a high energy density and a high reference electrode potential.

However, electrolytes conventionally used in lithium secondary batteries are liquid electrolytes such as organic solvents. Accordingly, safety problems such as leakage of electrolytes and risk of fire may continuously occur.

Recently, solid state batteries including solid electrolytes, rather than liquid electrolytes, have been used to improve the safety feature of the lithium secondary battery and have attracted much attention. For example, solid electrolytes are typically safer than liquid electrolytes due to non-combustible or flame retardant properties.

To improve safety, sulfur-free solid electrolytes have been developed, which avoid the formation of hydrogen sulfide when exposed to the atmosphere. Besides that, lithium halides solid electrolytes show high ionic conductivity and oxidative stability.

Wang et al (Nature Communications 2021, 12, 4410) describe the synthesis of Li₂ZrCl₆ and a battery comprising a cathode, an anode and Li₂ZrCl₆ as solid electrolyte.

WO2021/161604 A1 contemplates the synthesis of an aluminum substituted fluoride-based solid electrolyte such as Li_{2.5}Zr_{0.5}Al_{0.5}F₆ and Li_{2.6}Zr_{0.4}Al_{0.6}F₆.

It is an object of the present invention to provide a metal-substituted lithium-rich halide-based solid electrolyte.

It is a further object of the present invention to provide a method for manufacturing said solid electrolyte.

It is a further object of the present invention to provide a battery comprising said solid electrolyte.

### SUMMARY OF THE INVENTION

In a first aspect an object of the present invention is achieved by providing a solid electrolyte having a composition according to formula (I)

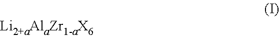

wherein 0<a<1, and X is selected from the group consisting of Cl, Br, I and any combination of the group consisting of F, Cl, Br and I. In preferred embodiments the solid electrolyte is according to the invention, wherein 0.2<a<0.3 or 0.3<a<1.0.

The present inventors have surprisingly found that these aluminum-substituted lithium-rich zirconium- and halide-based solid electrolyte compositions display an increase in ionic conductivity, as demonstrated in the appended examples.

In order to overcome a safety problem due to the presence of sulfur in solid electrolyte compositions, the present inventors explored halide-based solid electrolytes, because they are ionically conductive, easily deformable and have a high oxidative stability.

In a further aspect the invention provides a method for manufacturing said solid electrolyte.

In a further aspect the invention provides a battery comprising the solid electrolyte according to the invention.

The present inventors have surprisingly found that the battery comprising the solid electrolyte according to the invention has an increased capacity as compared to a battery comprising Li₂ZrCl₆ as solid electrolyte, in particular when a bilayer separator is used comprising the solid electrolyte of the invention and a sulfide solid electrolyte in a defined configuration.

Without wishing to be bound by any theory the present inventors believe that the presence of a bilayer limits the side reactions that occurs in the batteries, especially to avoid reactions between the sulfide electrolyte and the cathode, in particular the solid electrolyte comprised in the cathode.

### BRIEF DESCRIPTION OF THE FIGURES

FIG. 1: X-ray diffraction patterns of CEX1, EX1, EX3-4 and EX6.

FIG. 2: Cells 1-4 cycled at C/20 between 1.9 V and 3.7 V vs Li/In.

### DETAILED DESCRIPTION

In the drawings and the following detailed description, preferred embodiments are described in detail to enable practice of the invention. Although the invention is described with reference to these specific preferred embodiments, it will be understood that the invention is not limited to these preferred embodiments. To the contrary, the invention includes numerous alternatives, modifications and equivalents as will become apparent from consideration of the following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

The term “solid-state battery” as used herein refers to a cell or a battery that includes only solid or substantially solid-state components such as solid electrodes (e.g. anode and cathode) and a solid electrolyte.

X-Ray diffraction (XRD) as referred to herein, refers to XRD experiments performed using Bruker D8 diffractometers equipped with Cu-Kα radiation (λ_{Cu}=1.5418 Å). Preferably, the sample preparation is done in an Ar-filled glove box and placed in an air-tight sample holder capped with a Be window.

Measurements of electrochemical impedance spectroscopy as referred herein were made using a frequency response analyser (MTZ-35, Biologic) and an intermediate temperature system (ITS, Biologic). Preferably, powders were pelletized between two carbon paper using a Ø6 mm die in a uniaxial hydraulic press (around 1.5 ton) and the pellets were loaded in an Ar-filled glovebox into an air-tight sample holder (CESH, Biologic) and measured at temperatures ranging from 25 to 75° C. Preferably, a frequency range of 35 MHz to 1 Hz and an applied voltage of 50 mV were utilized. The ionic conductivities were determined by extracting the resistances from the Nyquist plots and calculating the conductivities taking the dimensions of the pellets into account. The activation energy (Eₐ) for Li ion diffusion was calculated from the slope of the Arrhenius plot. In preferred embodiments the reported ionic conductivity is measured at 25° C. In the context of the present invention a liquid shall be considered to be an organic or aqueous compound which is liquid in standard conditions for temperature and pressure as defined by the IUPAC. Hereby the boiling point and the melting point shall be considered to be the boiling point and the melting point at standard atmospheric pressure, i.e. at 101325 Pa. As appreciated by the skilled person the presence of the organic liquid can be determined via thermogravimetric analysis (TGA) or nuclear magnetic resonance (NMR) spectroscopy and the presence of the aqueous liquid can be determined via Karl Fisher titration.

The term “solid electrolyte” as used herein refers to an electrolyte being essentially free of any liquid. The term “essentially free of liquid” means that the solid electrolyte comprises less than 10 wt. % of a liquid by total weight of the solid electrolyte, preferably less than 7.5 wt. %, more preferably less than 5 wt. %, even more preferably less than 2.5 wt. %, most preferably less than 1 wt. % by total weight of the solid electrolyte. In a more preferred embodiment the solid electrolyte comprises less than 1000 ppm of a liquid by total weight of the solid electrolyte, preferably less than 500 ppm, more preferably less than 100 ppm, even more preferably less than 50 ppm, most preferably less than 10 ppm by total weight of the solid electrolyte.

The term “solid-state battery” as used herein and in the claims refers to a cell or a battery that includes only solid or substantially solid-state components such as solid electrodes (e.g. anode and cathode) and a solid electrolyte.

### Solid Electrolyte

In a first aspect the invention provides a solid electrolyte having a composition according to formula (I)

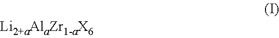

wherein 0.0<a<1, and
X is selected from the group consisting of Cl, Br, I and any combination of the group consisting of F, Cl, Br and I.

In preferred embodiments the solid electrolyte is according to the invention, wherein 0.05≤a≤0.95, preferably 0.075≤a≤0.9, more preferably 0.1≤a≤0.85. In certain preferred embodiments the solid electrolyte is according to the invention, wherein 0.05≤a≤0.7, preferably 0.1≤a≤0.6, more preferably 0.2≤a≤0.5.

In preferred embodiments the solid electrolyte is according to the invention, wherein 0.2<a<0.3 or 0.3<a<1.0.

In preferred embodiments the solid electrolyte is according to the invention, wherein 0.21≤a≤0.29, preferably 0.22≤a≤0.28, more preferably 0.23≤a≤0.27, even more preferably 0.24≤a≤0.26, most preferably a is about 0.25. In preferred embodiments the solid electrolyte is according to the invention, wherein 0.31≤a≤0.99, preferably 0.35≤a≤0.90 more preferably 0.39≤a≤0.80. In certain preferred embodiments the solid electrolyte is according to the invention, wherein 0.35≤a≤0.70, preferably 0.37≤a≤0.60, even more preferably 0.38≤a≤0.55, most preferably 0.40≤a≤0.50. In highly preferred embodiments a is about 0.40 or 0.50.

In certain preferred embodiments the solid electrolyte is according to the invention, wherein X is Cl, Br, I or a combination thereof; preferably X is Cl, Br or a combination thereof; preferably X is Cl.

In certain preferred embodiments the solid electrolyte is according to the invention, wherein X is Cl, Br or I; preferably X is Cl or Br; preferably X is Cl.

In accordance with preferred embodiments of the invention, the solid electrolyte is provided wherein at least 50% mol of X represents Cl, preferably at least 80 mol % of X represents Cl, most preferably X represents Cl.

In accordance with preferred embodiments of the invention, the solid electrolyte is provided wherein X represents Cl, Br and I or a combination thereof and wherein at least 50% mol of X represents Cl, preferably at least 80 mol % of X represents Cl, most preferably X represents Cl.

In accordance with preferred embodiments of the invention, the solid electrolyte is provided wherein at least 50 mol % of X represents Br, preferably at least 80 mol % of X represents Br, most preferably X represents Br.

In accordance with preferred embodiments of the invention, the solid electrolyte is provided wherein X represents Cl, Br and I or a combination thereof and wherein at least 50 mol % of X represents Br, preferably at least 80 mol % of X represents Br.

In accordance with preferred embodiments of the invention, the solid electrolyte is provided wherein at least 50 mol % of X represents I, preferably at least 80 mol % of X represents I, most preferably X represents I.

In accordance with preferred embodiments of the invention, the solid electrolyte is provided wherein X represents Cl, Br and I or a combination thereof and wherein at least 50 mol % of X represents I, preferably at least 80 mol % of X represents I.

In preferred embodiments the solid electrolyte is according to the invention, wherein the molar ratios of Li:Al:Zr:X are between (2-3):(0.01-0.99):(0.01-0.99):(5.5-6.5), preferably (2.1-2.9):(0.1-0.9):(0.1-0.9):(5.9-6.1), more preferably (2.1-2.6):(0.1-0.6):(0.4-0.9):(6).

In certain preferred embodiments the solid electrolyte is according to the invention, wherein the molar ratios of Li:Al:Zr:X are between (2.2-2.3):(0.2-0.3):(0.7-0.8):(5.9-6.1), preferably (2.23-2.27):(0.23-0.27):(0.73-0.77):(5.9-6.1), more preferably (2.25):(0.25):(0.75):(6).

In certain preferred embodiments the solid electrolyte is according to the invention, wherein the molar ratios of Li:Al:Zr:X are between (2.3-3.0):(0.3-1.0):(0.0-0.7):(5.9-6.1), preferably (2.37-2.6):(0.37-0.6):(0.4-0.63):(5.9-6.1), more preferably (2.4-2.5):(0.4-0.5):(0.5-0.6):(6).

In preferred embodiments the solid electrolyte is according to the invention having a purity of at least 90%, preferably at least 95%, more preferably at least 99%, as determined by XRD.

In some embodiments the crystal structure of the solid electrolyte may also be empirically determined for example, by X-ray diffraction by observing diffraction peaks around at 2θ=16±1°, 29.5±1°, 26±1°, 31.5±1°, 31.5±1°, 34.0±1°, 41.0±1° and 45.5±1° using CuKα-ray wavelength.

In preferred embodiments the solid electrolyte is according to the invention having a P-31m (164) space group, preferably with a lattice parameter a (Å) between 10.951 and 11.020 and c (Å) between 5.910 and 6.044, as determined by least square refinements of XRD profile and/or Rietveld analysis.

In preferred embodiments the solid electrolyte is according to the invention having a conductivity between 0.05 and 10 mS/cm, preferably between 0.1 and 2 mS/cm, more preferably between 0.15 and 1 mS/cm.

In certain preferred embodiments the solid electrolyte is according to the invention, wherein
X is Cl;
0.05≤a≤0.7, preferably 0.1≤a≤0.6, most preferably 0.2≤a≤0.5.

In certain preferred embodiments the solid electrolyte is according to the invention, wherein
X is Cl;
0.21≤a≤0.29, preferably 0.22≤a≤0.28, more preferably 0.24≤a≤0.26, even more preferably a=0.25.

In certain preferred embodiments the solid electrolyte is according to the invention, wherein
X is Cl;
0.35≤a≤0.70, preferably 0.37≤a≤0.60, more preferably 0.39≤a≤0.50, even more preferably a=0.40.

In certain preferred embodiments the solid electrolyte is according to the invention, wherein
X is Cl;
0.35≤a≤0.70, preferably 0.37≤a≤0.60, more preferably 0.45≤a≤0.55, even more preferably a=0.50.

In certain more preferred embodiments the solid electrolyte is according to the invention, wherein the solid electrolyte is according to formula (II)

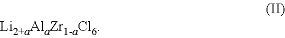

In certain preferred embodiment the solid electrolyte of the invention is according to formula (II), wherein 0.05≤a≤0.7, preferably 0.1≤a≤0.6, most preferably 0.2≤a≤0.5.

In certain preferred embodiments the solid electrolyte of the invention is according to formula (II), wherein 0.2<a<0.3 or 0.3<a<1.0.

In certain preferred embodiments the solid electrolyte of the invention is according to formula (II), wherein 0.21≤a≤0.29, preferably 0.22≤a≤0.28, more preferably 0.24≤a≤0.26, even more preferably a=0.25.

In certain preferred embodiments the solid electrolyte is according to formula (II), wherein 0.21≤a≤0.29, preferably 0.22≤a≤0.28, more preferably 0.23≤a≤0.27, even more preferably 0.24≤a≤0.26, most preferably a is about 0.25. In certain preferred embodiments the solid electrolyte is according to formula (II), wherein 0.31≤a≤0.99, preferably 0.35≤a≤0.90 more preferably 0.39≤a≤0.80.

In certain preferred embodiments the solid electrolyte is according to formula (II), wherein 0.35≤a≤0.70, preferably 0.37≤a≤0.60, even more preferably 0.38≤a≤0.55, most preferably 0.40≤a≤0.50. In highly preferred embodiments a is about 0.40 or 0.50.

In more preferred embodiments the solid electrolyte is according to the invention, wherein the solid electrolyte is according to formula (II)a-g, preferably according to formula (II)a-e, more preferably according to formula (II)b-e:

| | |
|---|---|
| Li_{2.1}Al_{0.1}Zr_{0.9}Cl₆ | (II)a |
| Li_{2.2}Al_{0.2}Zr_{0.8}Cl₆ | (II)b |
| Li_{2.25}Al_{0.25}Zr_{0.75}Cl₆ | (II)c |
| Li_{2.3}Al_{0.3}Zr_{0.7}Cl₆ | (II)d |
| Li_{2.4}Al_{0.4}Zr_{0.6}Cl₆ | (II)e |
| Li_{2.5}Al_{0.5}Zr_{0.5}Cl₆ | (II)f |
| Li_{2.6}Al_{0.6}Zr_{0.4}Cl₆ | (II)g |

In certain preferred embodiment the solid electrolyte is according to formula (II)c, (II)e or (II)f.

In certain preferred embodiments the solid electrolyte of the invention is according to formula (II)a, preferably having a conductivity between 0.05 and 0.5 mS/cm, more preferably between 0.1 and 0.25 mS/cm, most preferably about 0.11 mS/cm.

In certain preferred embodiments the solid electrolyte of the invention is according to formula (II)b, preferably having a conductivity between 0.05 and 1 mS/cm, more preferably between 0.25 and 0.75 mS/cm, most preferably about 0.52 mS/cm.

In certain preferred embodiments the solid electrolyte of the invention is according to formula (II)c, preferably having a conductivity between 0.05 and 1 mS/cm, more preferably between 0.50 and 0.95 mS/cm, most preferably about 0.88 mS/cm.

In certain preferred embodiments the solid electrolyte of the invention is according to formula (II)d, preferably having a conductivity between 0.1 and 1 mS/cm, more preferably between 0.25 and 0.50 mS/cm, most preferably about 0.41 mS/cm.

In certain preferred embodiments the solid electrolyte of the invention is according to formula (II)e, preferably having a conductivity between 0.1 and 1 mS/cm, more preferably between 0.3 and 0.70 mS/cm, most preferably about 0.54 mS/cm.

In certain preferred embodiments the solid electrolyte of the invention is according to formula (II)f, preferably having a conductivity between 0.1 and 1 mS/cm, more preferably between 0.25 and 0.75 mS/cm, most preferably about 0.50 mS/cm.

In certain preferred embodiments the solid electrolyte of the invention is according to formula (II)g, preferably having a conductivity between 0.05 and 0.5 mS/cm, more preferably between 0.1 and 0.25 mS/cm, most preferably about 0.18 mS/cm.

In certain more preferred embodiments the solid electrolyte of the invention is according to formula (III)

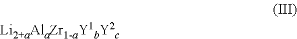

wherein 0<a<1;
wherein Y¹ and Y² are independently selected from the group consisting of F, Cl, Br and I;
wherein b+c=6; and
wherein Y¹≠Y².

In certain more preferred embodiments the solid electrolyte is according to formula (III), wherein 0.05≤a≤0.7, preferably 0.1≤a≤0.6, most preferably 0.2≤a≤0.5. Even more preferably 0.21≤a≤0.4, preferably 0.22≤a≤0.3, even preferably 0.23≤a≤0.26. In a certain most preferred embodiment a is about 0.25.

In certain more preferred embodiments the solid electrolyte is according to formula (III), wherein Y¹═F and Y² is selected from the group consisting of Cl, Br and I, preferably Cl and Br, most preferably Cl.

In certain more preferred embodiments the solid electrolyte is according to formula (III), wherein Y¹═Cl and Y² is selected from the group consisting of F, Br and I, preferably Br and I, more preferably Br.

In certain more preferred embodiments the solid electrolyte is according to formula (III), wherein Y¹═Br and Y² is selected from the group consisting of F, Cl and I, preferably Cl and I, more preferably Cl.

In certain more preferred embodiments the solid electrolyte is according to formula (III), wherein Y¹═I and Y² is selected from the group consisting of F, Cl and Br, preferably Cl and Br, more preferably Cl.

In certain preferred embodiments the solid electrolyte is according to formula (III), wherein 5≤b<6 and 0<c≤1.

In certain highly preferred embodiments the solid electrolyte is according to formula (III)a-l, preferably according to (III)d-l, more preferably according to (III)e, (III)f, (III)h, (III)i, (III)k or (III)r:

| | |
|---|---|
| Li₂₊ₐAlₐZr₁₋ₐF_{b}Cl_{c} | (III)a |
| Li₂₊ₐAlₐZr₁₋ₐF_{b}Br_{c} | (III)b |
| Li₂₊ₐAlₐZr₁₋ₐF_{b}I_{c} | (III)c |
| Li₂₊ₐAlₐZr₁₋ₐCl_{b}F_{c} | (III)d |
| Li₂₊ₐAlₐZr₁₋ₐCl_{b}Br_{c} | (III)e |
| Li₂₊ₐAlₐZr₁₋ₐCl_{b}I_{c} | (III)f |
| Li₂₊ₐAlₐZr₁₋ₐBr_{b}F_{c} | (III)g |
| Li₂₊ₐAlₐZr₁₋ₐBr_{b}Cl_{c} | (III)h |
| Li₂₊ₐAlₐZr₁₋ₐBr_{b}I_{c} | (III)i |
| Li₂₊ₐAlₐZr₁₋ₐI_{b}F_{c} | (III)j |
| Li₂₊ₐAlₐZr₁₋ₐI_{b}Cl_{c} | (III)k |
| Li₂₊ₐAlₐZr₁₋ₐI_{b}Br_{c} | (III)l |

In certain preferred embodiments the solid electrolyte is according to formula (III)a-c.

In certain highly preferred embodiments the solid electrolyte is according to formula (III), preferably according to formula (III)a-(III)I, more preferably according to (III)d-l, even more preferably according to (III)e, (III)f, (III)h, (III)i, (III)k or (III)I or according to (III)a-c, most preferably according to (III)a-c; wherein

$$b = 5. and c = 1. , or$$

$$b = 5.1 and c = 0.9 , or$$

$$b = 5.2 and c = 0.8 , or$$

$$b = 5.25 and c = 0.75 , or$$

$$b = 5.3 and c = 0.7 , or$$

$$b = 5.4 and c = 0.6 , or$$

$$b = 5.5 and c = 0.5 , or$$

$$b = 5.6 and c = 0.4 , or$$

$$b = 5.7 and c = 0.5 , or$$

$$b = 5.75 and c = 0.25 , or$$

$$b = 5.8 and c = 0.2 , or$$

$$b = 5.9 and c = 0.1 ;$$

$$preferably b = 5.75 and c = 0.25 , or$$

$$b = 5.5 and c = 0.5 , or$$

$$b = 5.25 and c = 0.75 .$$

### Method for Manufacturing

In a second aspect the invention provides a method for manufacturing a solid electrolyte comprising the following steps:
a) providing a set of precursors comprising Li, Al, Zr and X;
b) mixing of the set of precursors to obtain the solid electrolyte;
wherein X is selected from the group consisting of Cl, Br, I and any combination of the group consisting of F, Cl, Br and I.

In certain preferred embodiments the solid electrolyte is according to the second aspect of invention, wherein X is Cl, Br, I or a combination thereof; preferably X is Cl, Br or a combination thereof; more preferably X is Cl or Br; even more preferably is Cl.

In a preferred embodiment the method for manufacturing a solid electrolyte is according to the second aspect of the invention, wherein the set of precursors comprises LiZ¹, AlZ²₃ and ZrZ³₄, wherein Z¹, Z² and Z³ are independently selected from the group consisting of Cl, Br, I and any combination thereof.

In a preferred embodiment the method for manufacturing a solid electrolyte is according to the second aspect of the invention, wherein Z¹, Z² and Z³ are the same halide selected from the group consisting of Cl, Br and I, preferably Cl and Br, more preferably Z¹═Z²═Z³═Cl.

In a third aspect the invention provides a method for manufacturing a solid electrolyte, preferably the solid electrolyte according to Formula (III), comprising the following steps:
a) providing a set of precursors comprising Li, Al, Zr, Y¹ and Y²;
b) mixing of the set of precursors to obtain the solid electrolyte;
wherein Y¹ and Y² are independently selected from the group consisting of F, Cl, Br and I; and wherein Y¹≠Y².

In certain preferred embodiments the solid electrolyte is according to the third aspect of the invention, wherein Y¹ and Y² are independently selected from the group consisting of F, Cl, Br and I; preferably F, Cl and Br, more preferably F and Cl; and wherein Y¹≠Y².

In certain preferred embodiments the solid electrolyte is according to the third aspect of the invention, wherein Y¹ and Y² are independently selected from the group consisting of F, Cl, Br and I; preferably Cl, Br and I, more preferably Cl and Br, and wherein Y¹≠Y².

In a preferred embodiment the method for manufacturing a solid electrolyte is according to the third aspect of the invention, wherein the set of precursors comprises LiZ¹, AlZ²₃ and ZrZ³₄, wherein Z¹, Z² and Z³ are independently selected from the group consisting of F, Cl, Br and I, preferably F, Cl and Br, more preferably F and Cl.

In certain highly preferred embodiments at least two of Z¹, Z² and Z³ are not the same halide. In certain highly preferred embodiments at most two of Z¹, Z² and Z³ are not the same halide. In certain more highly preferred embodiments Z¹═Cl, Z²═Cl and Z³═F.

In a certain preferred embodiment the method for manufacturing a solid electrolyte is according to the third aspect of the invention, wherein Z¹, Z² and Z³ are independently selected from the group consisting of F, Cl, Br and I; preferably Cl, Br and I, more preferably Cl and Br. In certain highly preferred embodiments at least two of Z¹, Z² and Z³ are not the same halide. In certain highly preferred embodiments at most two of Z¹, Z² and Z³ are not the same halide.

In highly preferred embodiments the method is according to the invention, preferably according to the second or third aspect of the invention, wherein the solid electrolyte is the solid electrolyte according to the first aspect of the invention.

As appreciated by the skilled person all embodiments related to the solid electrolyte according to first aspect of the invention relating to formula (I), formula (II), formula (III), purity level and conductivity level equally apply to the method for manufacturing the solid electrolyte according to the invention, in particular to the method according to the second aspect and/or to the third aspect of the invention.

In preferred embodiments the method is according to the invention, wherein the mixing of the set of precursors of step b) is for at least 15 minutes, preferably at least 0.5 hour, most preferably at least 1 hour.

As appreciated by the skilled person the following embodiments equally apply to the method of the second aspect of the invention as to the method of third aspect of the invention.

In preferred embodiments the method is according to the invention, wherein the mixing of the set of precursors of step b) is at most 60 hours, preferably at most 45 hours, most preferably at most 30 hours.

In preferred embodiments the method is according to the invention, wherein the mixing of the set of precursors of step b) is between 15 minutes and 60 hours, preferably between 0.5 hour and 45 hours, most preferably between 1 hours and 30 hours.

In preferred embodiments the method is according to the invention, wherein the mixing of the set of precursors of step b) with a mixing speed of 100-1000 rpm, preferably a mixing speed of 300-900 rpm, most preferably a mixing speed of 400-800 rpm.

A preferred embodiment is the method according to the invention, wherein the mixing of the set of precursors is carried out by using a mixing means, preferably the mixing means is as ball mill such as an electric ball mill, a vibration ball mill, a planetary ball mill, a vibration mixer mill or a SPEX mill; a bead mill; a homogenizer; a screw mixer; a horizontal mixer; a ploughshare mixer; a jar mill; a drum mill or a roller bench, more preferably the mixing means is an electric ball mill, a vibration ball mill, a planetary ball mill, most preferably a planetary ball mill. In a more preferred embodiment mixing of the set of precursors is carried out by adding one or more ceramic or zirconia balls, preferably zirconia balls, more preferably Yttrium doped zirconia balls, to the set of precursors to obtain the solid electrolyte. As appreciated by the skilled person the amount and size of the ceramic or zirconia balls are changed in view of the total solid amount of the set of precursors.

In preferred embodiments the method is according the invention, wherein the mixing of the set of precursors of step b) occurs at a temperature of at least 5° C., preferably at least 10° C., more preferably at least 15° C. A preferred embodiment is the method according to the invention, wherein the mixing of the set of precursors of step b) occurs at a temperature of less than 50° C., preferably less than 40° C., more preferably less than 30° C. A preferred embodiment is the method according to the invention, wherein the mixing of the set of precursors of step b) occurs at a temperature between 5 and 50° C., preferably a temperature between 1° and 40° C., more preferably a temperature between 15 and 30° C.

In certain preferred embodiments the method is according to the invention, wherein the mixing of the set of precursors of step b)
with a mixing time between 15 minutes and 60 hours, preferably between 0.5 hour and 45 hours, most preferably between 1 hour and 30 hours; and
with a mixing speed of 100-1000 rpm, preferably a mixing speed of 300-900 rpm, most preferably a mixing speed of 400-800 rpm.

### Product-by-Process

In a fourth aspect the invention concerns the solid electrolyte obtainable by the method according to the second aspect of the invention and/or according to the third aspect of the invention.

As appreciated by the skilled person all embodiments directed to the solid electrolyte according to the first aspect of the invention and/or the method according to the second aspect of the invention and/or the method according to the third aspect of the invention apply mutatis mutandis to solid electrolyte obtainable by the method according to the invention. For example, the various embodiments relating to formula (I), formula (II), formula (III), purity level and conductivity level as explained herein in the context of the solid electrolyte are equally applicable to the solid electrolyte obtainable by the method for manufacturing the solid electrolyte.

### Battery

A fifth aspect of the invention concerns a battery comprising an anode, a cathode and a solid electrolyte layer, wherein at least one of the cathode, the anode and the solid electrolyte layer comprises the solid electrolyte according to the invention. The present solid electrolyte of the invention can be used as a solid electrolyte layer of a solid lithium ion battery or a solid lithium primary cell, or as a solid electrolyte that is mixed with an electrode mixture for a cathode or a anode.

In a preferred embodiment the battery is a solid-state battery, preferably a lithium solid-state battery.

In a preferred embodiment the solid electrolyte layer comprises a first layer consisting of the solid electrolyte according to the first aspect of the invention and/or according to the third aspect of the invention, preferably according to the first aspect of the invention.

As appreciated by the skilled person all embodiments directed to the solid electrolyte according to the first aspect of the invention and/or the method according to the second aspect of the invention and/or the solid electrolyte obtainable by the method according to the fourth aspect of the invention apply mutatis mutandis to solid electrolyte present in the battery according to the fifth aspect of the invention. For example, the various embodiments relating to formula (I), formula (II), formula (III), purity level and conductivity level as explained herein in the context of the solid electrolyte are equally applicable to the solid electrolyte comprised in the battery according to the invention.

As appreciated by the skilled person the solid electrolyte layer is a separator layer or a membrane layer separating the anode and the cathode from one another.

A preferred embodiment is the battery according to the invention, wherein the solid electrolyte layer comprises a second layer consisting of a further solid electrolyte having a composition different from the solid electrolyte according to the invention. Preferably, the further solid electrolyte having a composition different from the solid electrolyte according to the invention is a sulfide solid electrolyte, more preferably the further solid electrolyte having a composition different from the solid electrolyte of the invention comprises Li, P and S. Typically, the following sulfur-containing compounds Li₆PS₅Cl (LPSCL), thio-LISICON (Li_{3.25}Ge_{0.25}P_{0.75}S₄), Li₂S—P₂S₅—LiCl, Li₂S—SiS₂, LiI—Li₂S—SiS₂, Li₂S—P₂S₅—LiCl, Li₂S—SiS₂, LiI—Li₂S—SiS₂, LiI—Li₂S—P₂S₅, LiI—Li₂SP₂O₅, LiI—Li₃PO₄—P₂S₅, Li₂S—P₂S₅, Li₃PS₄, Li₇P₃S₁₁, LiI—Li₂S—B₂S₃, Li₃PO₄—Li₂S—SiS₂, Li₃PO₄—Li₂S—SiS₂, Li₃PO₄—Li₂S—SiS₂, Li₁₀GeP₂S₁₂, Li_{9.54}Si_{1.74}P_{1.44}S_{11.7}Cl_{0.3}, and/or Li₇P₃S₁₁ may be suitable used. Even more preferably the further solid electrolyte having a composition different from the solid electrolyte according to the invention is an argyrodite-type solid electrolyte, most preferably Li₆PS₅W with W═F, Cl, Br, I; preferably W═Cl.

A preferred embodiment is the battery according to the invention, wherein the anode comprises anode active material (also known as negative electrode active material). Suitable electrochemically active anode materials are those known in the art. For example, the anode may comprise graphitic carbon, metallic lithium or a metal alloy comprising lithium, such as Li—In alloy, as the anode active material. Preferably the anode active material is Li—In alloy. A highly preferred embodiment is the battery according to the invention, wherein the anode comprises the anode active material and the solid electrolyte according to invention and/or the further solid electrolyte having a composition different from the solid electrolyte of the invention, preferably the further solid electrolyte having a composition different from the solid electrolyte.

A preferred embodiment is the battery according to the invention, wherein the cathode comprises cathode active material (also known as positive electrode active material) comprising Li, M, and O, wherein M comprises Ni and one or both of Mn and Co. Preferably, the cathode active material comprises Li, M, and O, wherein M comprises
Ni in a content x, wherein 55.0 mol %≤x≤95.0 mol %, relative to M;
Mn in a content y, wherein 0.0 mol %≤y≤40.0 mol %, relative to M;
Co in a content z, wherein 0.0 mol %≤z≤40.0 mol %, relative to M;
D in a content a, wherein 0.0 mol %≤a≤2.0 mol %, relative to M, wherein
   D is at least one element other than Li, Ni, Mn, Co, and 0;
wherein x+y+z+a is 100.0 mol %;

more preferably wherein M comprises:
Ni in a content x, wherein 70.0 mol %≤x≤90.0 mol %, relative to M;
Mn in a content y, wherein 10.0 mol %≤y≤30.0 mol %, relative to M;
Co in a content z, wherein 10.0 mol %≤z≤30.0 mol %, relative to M;
D in a content a, wherein 0.0 mol %≤a≤2.0 mol %, relative to M, wherein
   D is at least one element other than Li, Ni, Mn, Co, and O;
wherein x+y+z+a is 100.0 mol %;

most preferably wherein M comprises:
Ni in a content x, wherein 75.0 mol %≤x≤85.0 mol %, relative to M;
Mn in a content y, wherein 15.0 mol %≤y≤25.0 mol %, relative to M;
Co in a content z, wherein 15.0 mol %≤z≤25.0 mol %, relative to M;
D in a content a, wherein 0.0 mol %≤a≤2.0 mol %, relative to M, wherein
   D is at least one element other than Li, Ni, Mn, Co, and O;
wherein x+y+z+a is 100.0 mol %.

In some particularly preferred embodiments, x is about 80 mol %, y is about 10 mol % and z is about 10 mol %. This is also known as NMC 811.

In some particularly preferred embodiments a=0.0 mol %.

In certain preferred embodiments the cathode active material of the invention comprises single-crystalline particles. In the context of the present invention a particle is considered to be single-crystalline if it consists of only one grain or at most five grains, preferably at most three grains, as observed by Scanning Electron Microscope (SEM) or Transmission Electron Microscope (TEM), preferably by observing grain boundaries of the particle. A grain boundary is defined as the interface between two grains in a particle, preferably wherein the atomic planes of the two grains are aligned to different orientations and meet as a crystalline discontinuity.

In certain preferred embodiments the present invention provides the positive electrode active material according to the invention, wherein said positive electrode active material is a powder comprising single particles and/or secondary particles, wherein each of the single particles consist of only one primary particle and each of the secondary particles consist of at least two primary particles and at most twenty primary particles as observed in a SEM image. Preferably, at least 30% of the particles, more preferably at least 50% of the particles, constituting the powder observed in a SEM image are the single particles and/or the secondary particles. The number of primary particles constituting the single particles and/or the secondary particles are determined in a field of view of at least 45 μm×at least 60 μm (i.e. of at least 2700 μm²), preferably of: at least 100 μm×100 μm (i.e. of at least 10,000 μm².

The particles in the image should be well distributed therefore avoiding overlap between particles. This can be achieved by pouring a small amount of powder sample to the adhesive attached on the SEM sample holder and blowing air to remove the excess powder.

In the context of the present invention primary particles are distinguished from each other in a SEM image by observing grain boundaries between the primary particles. A grain boundary is defined as the interface between two primary particles, preferably wherein the atomic planes of the two primary particles are aligned to different orientations and meet as a crystalline discontinuity.

A highly preferred embodiment is the battery according to the invention, wherein the cathode comprises the cathode active material and the solid electrolyte according to invention and/or the further solid electrolyte having a composition different from the solid electrolyte of the invention, preferably the solid electrolyte according to invention.

In a highly preferred embodiment the cathode is added on the solid electrolyte layer, wherein the first layer consisting of the solid electrolyte according to the invention comprised in the solid electrolyte layer is laminated or cast on the cathode. In a highly preferred embodiment the anode is added on the solid electrolyte layer, wherein the second layer consisting of the further solid electrolyte having a composition different from the solid electrolyte of the invention comprised in the solid electrolyte layer is laminated or cast on the anode. Worded differently, the battery according to the invention has the following configuration, wherein the solid electrolyte layer acts as a separator between the cathode and anode, such as: “the cathode//the solid electrolyte layer//the anode”, preferably “the cathode active material+the solid electrolyte according to the invention//the first layer consisting of the solid electrolyte of the invention/the second layer consisting of the further electrolyte having a composition different from the solid electrolyte according to the invention//the anode active material+the further electrolyte having a composition different from the solid electrolyte according to the invention”, more preferably “the cathode active material+the solid electrolyte having a composition according to formula (I)//the first layer consisting of solid electrolyte having a composition according to formula (I)/the second layer consisting of the sulfide solid electrolyte//the anode active material+the sulfide solid electrolyte”. For example, but not limiting to the invention, the battery has the following configuration: “NMC811+Li_{2.25}Al_{0.25}Zr_{0.75}Cl₆//Li_{2.25}Al_{0.25}Zr_{0.75}Cl₆/Li₆PS₅Cl//Li—In alloy+Li₆PS₅Cl”. As appreciated by the skilled person, the battery of the invention is configured such that the anode and cathode are physically separated from each other by the solid electrolyte layer, preferably the cathode is in physical contact with the first layer consisting of the solid electrolyte of the invention and the anode is in physical contact with the second layer consisting of the further electrolyte having a composition different from the solid electrolyte according to the invention and the cathode is not in physical contact with the second layer consisting of the further electrolyte having a composition different from the solid electrolyte according to the invention and the anode is not in physical contact with the first layer consisting of the solid electrolyte of the invention.

As appreciated by the skilled person the battery may further comprise one or more layers consisting of the solid electrolyte according to the invention and/or the further electrolyte having a composition different from the solid electrolyte and/or any other of electrolyte, preferably any other electrolyte.

In a preferred embodiment the battery according to the invention has a capacity of at least 160 mAh/g, more preferably of at least 180 mAh/g, most preferably of at least 200 mAh/g. As understood by the skilled person the capacity (Q−Q₀) is measured at C/20 between 1.9 V and 3.7 V vs Li/In.

### Method for Manufacturing the Battery

A sixth aspect of the invention concerns a method for manufacturing a battery, preferably the battery according to the fourth aspect of the invention, comprising the following steps:
(a) providing a cathode, preferably the cathode as defined herein,
(b) providing an anode, preferably the anode as defined herein,
(c) providing the solid electrolyte layer as defined herein,
(d) forming the battery by assembling the cathode, the anode, and the electrolyte into a battery.

As appreciated by the skilled person all embodiments directed to the battery according to the sixth aspect of the invention apply mutatis mutandis to the method for manufacturing said battery. For example, the various embodiments relating to the configuration of the battery as explained herein in the context of the battery are equally applicable to the method for manufacturing said battery.

In certain highly preferred embodiment step (d) comprises the following steps:
(d1) the cathode is added on the solid electrolyte layer, wherein the first layer consisting of the solid electrolyte according to the invention comprised in the solid electrolyte layer is laminated or cast on the cathode, and
(d2) the anode is added on the solid electrolyte layer, wherein the second layer consisting of the further solid electrolyte having a composition different from the solid electrolyte of the invention comprised in the solid electrolyte layer is laminated or cast on the anode.

In certain highly preferred embodiment step (d) comprises the following steps:
(d1′) the anode is added on the solid electrolyte layer, wherein the second layer consisting of the further solid electrolyte having a composition different from the solid electrolyte of the invention comprised in the solid electrolyte layer is laminated or cast on the anode, and
(d2′) the cathode is added on the solid electrolyte layer, wherein the first layer consisting of the solid electrolyte according to the invention comprised in the solid electrolyte layer is laminated or cast on the cathode.

### Use

A seventh aspect of the invention concerns a use of the solid electrolyte according to the invention in a battery, preferably a solid-state-battery, most preferably a lithium solid-state-battery.

An eight aspect of the present invention concerns a use of the battery according to the invention in either one of a portable computer, a tablet, a mobile phone, an energy storage system, an electric vehicle or in a hybrid electric vehicle, preferably in a vehicle or in a hybrid electric vehicle.

The invention is further illustrated in the following examples:

### Examples

### Description of Testing Methods

### Synthesis Protocol

All the synthesis work and sample treatment were carried out in Ar filled glovebox. For each example stoichiometric ratios of reagents, LiCl (ultra dry, 99.9% metals basis, Alfa Aesar), ZrCl₄ (ultra dry, 99.5% metals basis, Alfa Aesar) and AlCl₃ (ultra dry, 99.99% metals basis, Alfa Aesar) were mixed to obtain a 1 g batch of precursor in a 45 mL ball milling jar. Stochiometric ratios of LiCl, ZrCl₄ and AlF₃ were used for EX8. The precursors were transferred into a Fritsch Pulverisette 7 classic line 45 mL zirconia ball-milling jar along with 10 Yttrium doped zirconia balls of 10 mm diameter (the ball:powder ratio was 1:40 or 1:30 in mass). The precursors were milled at 600 rpm for a total effective time of 10 hours affording the solid electrolyte.

### X-Ray Diffraction

All samples were measured at room temperature using Bruker D8 diffractometer with Cu-K_{α} radiation (λCu=1.5418 Å). As every sample is sensitive to moisture, the preparation was carried out in Ar-filled glove box and put in an air-tight sample holder with a Be window (250 μm thickness).

### Impedance Spectroscopy

Measurements of electrochemical impedance spectroscopy were made using a frequency response analyser (MTZ-35, Biologic) and an intermediate temperature system (ITS, Biologic). Powders were pelletized between two carbon paper using a Ø6 mm die in a uniaxial hydraulic press (around 1.5 ton). The pellets were loaded in an Ar-filled glovebox into an air-tight sample holder (CESH, Biologic) and measured at temperatures ranging from 25 to 75° C. A frequency range of 35 MHz to 1 Hz and an applied voltage of 50 mV were utilized. The ionic conductivities were determined by extracting the resistances from the Nyquist plots and calculating the conductivities taking the dimensions of the pellets into account. The activation energy (Eₐ) for Li ion diffusion was calculated from the slope of the Arrhenius plot. The reported conductivity values are measured at 25° C.

### Assembly of Batteries

All examples were carried out in an Ar-filled Glovebox. Bare single crystal NMC811 was used as cathode active material. A cathode composite of 70 wt. % NMC811 and 30 wt. % solid electrolyte (either Li₂ZrCl₆ (=LZC) or Li_{2.25}Al_{0.25}Zr_{0.75}Cl₆ (=LAZC)) was prepared by hand grinding in a mortar without any carbon additive. Lithium-Indium alloy was used as anode active material. The anode composite was hand grinded in a mortar with a weight ratio of Li_{0.5}In 60 wt. % and Li₆PS₅Cl (NEI Corporation) 40 wt. %. The cell was assembled between two stainless steel pistons (10 mm diameter). First 50 mg of solid electrolyte was pressed at 1 ton during 1 min forming the separator layer. Depending on the set-up of the cell this step might have been repeated a second time to have two layers of separator (monolayer set-up, one step with Li₆PS₅Cl (NEI Corporation); bilayer setup, two steps with halide-based solid electrolytes (either Li₂ZrCl₆ (=LZC) or Li_{2.25}Al_{0.25}Zr_{0.75}Cl₆ (=LAZC)) and Li₆PS₅Cl (argyrodite or Arg; NEI Corporation). Then the cathode composite was added on one side (in the bilayer system on the Li₂ZrCl₆ (=LZC) or Li_{2.25}Al_{0.25}Zr_{0.75}Cl₆ (=LAZC)) corresponding to 12 mg of cathode active material and 60 mg of the anode composite was added on the other side (in the bilayer system on the Li₆PS₅Cl side). A pressure of 3 tons is finally applied during 3 min. The full stack is then placed in an air-tight jar with a vice to maintain an internal pressure of 1 ton. The cells were cycled at C/20 between 1.9 V and 3.7 V vs Li/In. Overall, the following cells were prepared:
Cell 1: NMC+LAZC//LAZC/Arg//Li—In+Arg (LAZC bilayer)
Cell 2: NMC+LAZC//Arg//Li—In+Arg (LAZC monolayer)
Cell 3: NMC+LZC//LZC/Arg//Li—In+Arg (LZC bilayer)
Cell 4: NMC+LZC//Arg//Li—In+Arg (LZC monolayer)

### Examples

Table 1 displays the overall formula of the examples synthesized via the general synthesis protocol described above with their corresponding ionic conductivity.

TABLE 1
Overall formula and ionic conductivities of CEX1 and EX1-7.

| | | Ionic Conductivity at |
|---|---|---|
| Examples | Formula | 25° C. (mS · cm⁻¹) |
| CEX1 | Li₂Zr₁Cl₆ | 0.19 |
| EX1 | Li_{2.1}Al_{0.1}Zr_{0.9}Cl₆ | 0.11 |
| EX2 | Li_{2.2}Al_{0.2}Zr_{0.8}Cl₆ | 0.52 |
| EX3 | Li_{2.25}Al_{0.25}Zr_{0.75}Cl₆ | 0.88 |
| EX4 | Li_{2.3}Al_{0.3}Zr_{0.7}Cl₆ | 0.41 |
| EX5 | Li_{2.4}Al_{0.4}Zr_{0.6}Cl₆ | 0.54 |
| EX6 | Li_{2.5}Al_{0.5}Zr_{0.5}Cl₆ | 0.50 |
| EX7 | Li_{2.6}Al_{0.6}Zr_{0.4}Cl₆ | 0.18 |
| CEX2 | Li₂ZrF₆ | 10⁻⁹* |
| CEX3 | Li_{2.25}Al_{0.25}Zr_{0.75}F₆ | 10⁻⁸ |
| EX8 | Li_{2.25}Al_{0.25}Zr_{0.75}Cl_{5.25}F_{0.75} | 0.20 |

*Ionic conductivity measured at 120° C.
**A mixture of two crystal structures is obtained.

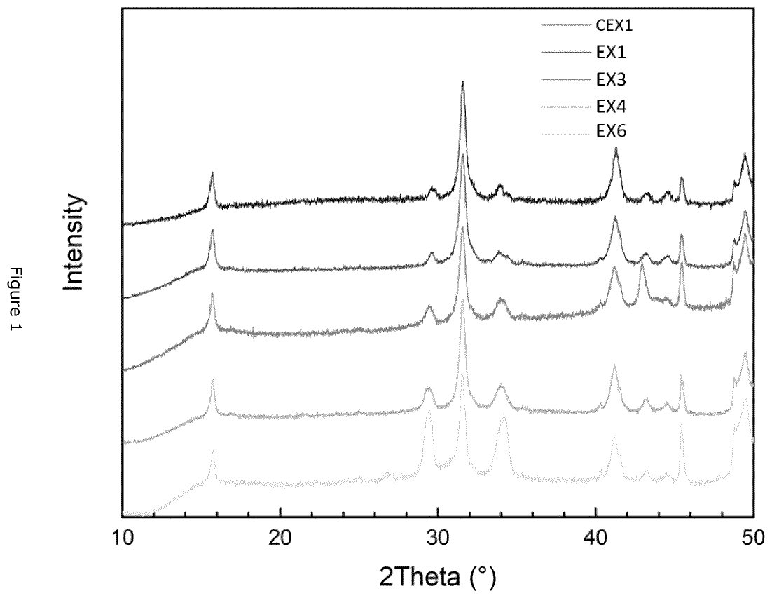

Profile matching of powder X-ray diffraction data suggest that the crystal structure is preserved for EX1, 3, 4 and 6. No peaks corresponding to the precursors or other impurity phases are observed (See FIG. 1). The ionic conductivity of CEX2 is 10⁻⁹ at 120° C. For CEX3 Li_{2.25}Al_{0.25}Zr_{0.75}F₆ is not synthesized as expected, but a mixture of crystal structures (Trigonal-Li₂₊ₓAlₓZr₁₋ₓF₆ (P-31m) and Monoclinic-Li_{2+y}Al_{y}Zr_{1-y}F₆ (P12₁/c1)) is obtained in an almost 1:1 weight ratio. The ionic conductivity of this mixture is 10⁻⁸ S·cm⁻¹ at 25° C. and 10⁻⁵ S·cm⁻¹ at 120° C.

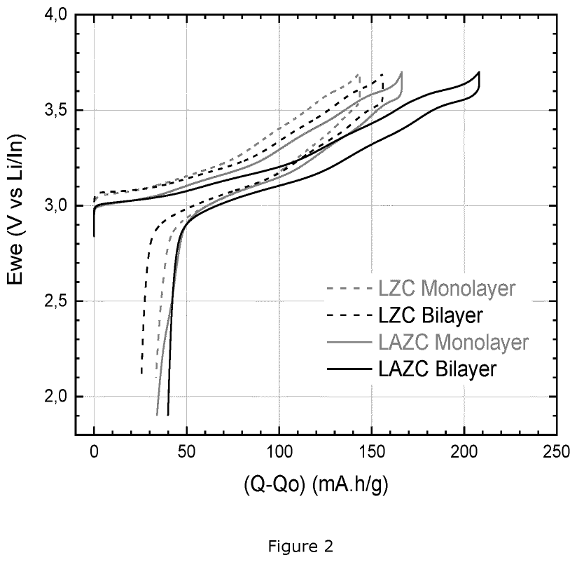

Table 2 displays the capacity of cells 1-4 after 1 cycle at C/20 between 1.9 V and 3.7 V vs Li/In. FIG. 2 is a graphical representation of Table 2.

TABLE 2
capacity of cells 1-4 after 1 cycle at
C/20 between 1.9 V and 3.7 V vs Li/In.

| | Charge capacity |
|---|---|
| Cell | (Q-Q₀; mAh/g) |
| Cell 1 | 208 |
| Cell 2 | 166 |
| Cell 3 | 156 |
| Cell 4 | 143 |

1-16. (canceled)

17. A solid electrolyte having a composition according to formula (I) 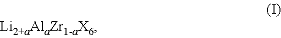
wherein 0.2<a<0.3 or 0.3<a<1.0, and
X is selected from the group consisting of Cl, Br, I and any combination of the group consisting of F, Cl, Br and I.

18. The solid electrolyte according to claim 17, wherein X is Cl, Br, I or a combination thereof.

19. The solid electrolyte according to claim 17, wherein 0.21≤a≤0.29.

20. The solid electrolyte according to claim 17, wherein 0.31≤a≤0.99.

21. The solid electrolyte according to claim 20, wherein 0.35≤a≤0.70.

22. The solid electrolyte according to claim 17, wherein X is selected from the group consisting of Cl, Br and I.

23. The solid electrolyte according to claim 17, having a composition according to formula (II)

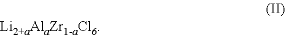

24. The solid electrolyte according to claim 23, having a composition according to formula (II)c, (II)e or (II)f:

| | |
|---|---|
| Li_{2.25}Al_{0.25}Zr_{0.75}Cl₆ | (II)c |
| Li_{2.4}Al_{0.4}Zr_{0.6}Cl₆ | (II)e |
| Li_{2.5}Al_{0.5}Zr_{0.5}Cl₆ | (II)f |

25. A solid electrolyte having a composition according to formula (III) 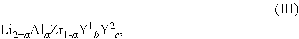
wherein 0<a<1;
wherein Y¹ and Y² are independently selected from the group consisting of F, Cl, Br and I,
wherein b+c=6,
wherein Y¹≠Y², and
wherein Y¹═F and Y² are independently selected from the group consisting of Cl, Br and I.

26. A method for manufacturing the solid electrolyte according to claim 17, comprising the following steps:
a) providing a set of precursors comprising Li, Al, Zr and X;
b) mixing of the set of precursors to obtain the solid electrolyte; wherein X is selected from the group consisting of Cl, Br, I and any combination of the group consisting of F, Cl, Br and I.

27. The method according to claim 26, wherein the set of precursors comprises LiZ¹, AlZ²₃ and ZrZ³₄, wherein Z¹, Z² and Z³ are independently selected from the group consisting of F, Cl, Br, I and any combination thereof; and wherein Z¹, Z² and Z³ are not the same halide.

28. A battery comprising an anode, a cathode and a solid electrolyte layer, wherein at least one of the cathode, the anode and the solid electrolyte layer comprises the solid electrolyte according to claim 17.

29. The battery according to claim 28, wherein the solid electrolyte layer comprises a first layer consisting of a solid electrolyte having a composition according to formula (I) 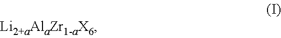
wherein 0.2<a<0.3 or 0.3<a<1.0, and
X is selected from the group consisting of Cl, Br, I and any combination of the group consisting of F, Cl, Br and I.

30. The battery according to claim 29, wherein the solid electrolyte layer comprises a second layer consisting of a further solid electrolyte having a composition different from the solid electrolyte according to claim 29.

31. The battery according to claim 30, wherein the further solid electrolyte having a composition different from the solid electrolyte according to claim 29 is a sulfide solid electrolyte.

32. Method for manufacturing a battery, comprising the following steps:
a) providing a cathode,
b) providing an anode,
c) providing the solid electrolyte layer as defined in claim 28,
d) forming the battery by assembling the cathode, the anode, and the solid electrolyte layer into a battery.
